(19) United States
(12) Patent Application Publication
(10) Pub. No.: US 2009/0228446 A1
(43) Pub. Date: Sep. 10, 2009

(54) Method for controlling load balancing in heterogeneous computer system

(75) Inventors: Takeshi Anzai, Yokohama (JP); Shinichi Kawamoto, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/218,360

(22) Filed: Jul. 11, 2008

(30) Foreign Application Priority Data
Mar. 6, 2008 (JP) 2008-057058

(51) Int. Cl. G06F 7/06; G06F 17/30

(52) U.S. Cl. 707/3; 707/E17.014

(57) ABSTRACT

The present invention comprises a load balancing server provided with a function for executing a DB query by proxy in a heterogeneous computer system having an AP server computer and a DB server computer. The load balancing server receives a DB query from an AP server, and determines whether the DB query is to be executed by proxy or transferred to the DB server computer and executed by a DB server, based on an element related to the extent of computer resource consumption resulting from the execution of the DB query. When it is determined that the DB query is to be executed by proxy, the DB query is executed by proxy, and when it is determined that the DB query is to be transferred to the DB server computer and executed by the DB server, the DB query is transferred to the DB server computer.

### CROSS-REFERENCE TO PRIOR APPLICATION

This application relates to and claims the benefit of priority from Japanese Patent Application number 2008-57058, filed on Mar. 6, 2008 the entire disclosure of which is incorporated herein by reference.

### BACKGROUND

The present invention generally relates to a technique for controlling load balancing in a heterogeneous computer system.

For example, technology for enhancing system performance by constructing a computer system that separates functions into an application server (AP server) that executes processing in accordance with a request from a client, and a database server (DB server) that executes a database query (DB query) outputted from the AP server, and operates the AP server and DB server as respectively independent computers, that is, a heterogeneous computer system, is known. In a system that is configured by a computer that runs the AP server (hereinafter to be called the “AP server computer”) and a computer that runs the DB server (hereinafter to be called the “DB server computer”), generally speaking, there is a tendency for the DB server computer to constitute a performance bottleneck.

By contrast, a technique for executing an SQL (Structured Query Language) specified in a request from a client via the AP server instead of by the DB server (hereinafter to be called the “execution-by-proxy technique) is also known. In the technique disclosed in Japanese Patent Application Laid-open No. 10-240591, the AP server executes a part of a SQL procedure by proxy. It is thus possible to reduce the extent to which the DB server computer constitutes a performance bottleneck by having the AP server execute the DB query by proxy. In this type technique, processing that is executed by proxy by the AP server is fixed, and the load on the DB server computer is lowered, but the AP server computer may become overloaded in line with quantitative changes in access.

Japanese Patent Application Laid-open No. 07-093238 discloses a load balancing technique in a computer system in which a plurality of server computers are installed equidistantly from a prescribed computer (hereinafter to be called the “homogeneous computer system”). More specifically, in Japanese Patent Application Laid-open No. 07-093238, a prescribed computer (data processing system) is connected to a plurality of server computers, the prescribed computer measures the load states of the respective server computers, dynamically determines the server computer with the lowest load as the server computer to process a request, and transfers the request to the determined server computer.

However, the length of the request time required to execute a request is not necessarily the same for all requests.

Japanese Patent Application Laid-open No. 2003-58518 discloses a technique for estimating the length of time for request execution in a homogeneous computer system.

A computer system in which the AP server executes a DB query in place of the DB server (hereinafter to be called “execution-by-proxy” is a heterogeneous computer system rather than a homogeneous computer system.

Techniques that are useful in a homogeneous computer system cannot simply be applied to a heterogeneous computer system like this, and even if it were hypothetically possible to apply these techniques, DB query load balancing cannot be carried out properly. One reason for this is that whereas a request is always transferred from the prescribed computer system to one of the plurality of server computers in the homogeneous computer system, a DB query is not always transferred from the AP server computer to the DB server computer in the heterogeneous computer system.

### SUMMARY

Therefore, an object of the present invention is to properly carry out load balancing in a heterogeneous computer system comprising an AP server computer and a DB server computer.

Other objects of the present invention should become clear from the explanations given hereinbelow.

A heterogeneous computer system comprising an AP server computer and a DB server computer comprises a load balancing server that comprises a function for executing a DB query by proxy. The load balancing server receives a DB query from the AP server, and, based on a computer resource consumption-related element, which is an element related to the extent to which a computer resource is consumed by the execution of the DB query, determines if this DB query will be executed by proxy, or if this DB query will be transferred to the DB server computer and executed by the DB server. If the determination is execution-by-proxy, the DB query is executed by proxy, and if the determination is to transfer the DB query to the DB server computer and to execute the DB query using the DB server, the DB query is transferred to the DB server computer.

### BRIEF DESCRIPTION OF THE DRAWINGS

FIG. 1 is a block diagram showing the configuration of a computer system related to a first embodiment of the present invention;

FIG. 2 shows the configuration of an AP server computer and a DB server computer of the first embodiment of the present invention;

FIG. 3 shows an example of a query execution result table of the first embodiment of the present invention;

FIG. 4 shows an example of a data dictionary table of the first embodiment of the present invention;

FIG. 5 shows an example of a table t1 that holds user data of the first embodiment of the present invention;

FIG. 6 shows an example of a table t2 that holds user data of the first embodiment of the present invention;

FIG. 7 shows an example of a server load determination criteria table of the first embodiment of the present invention;

FIG. 8 shows an example of a server computer statistical information table of the first embodiment of the present invention;

FIG. 9 shows an example of a network load information table of the first embodiment of the present invention;

FIG. 10 is a flowchart of the operation of a query execution unit of the first embodiment of the present invention;

FIG. 11 is a flowchart of the operation of a server load determination unit of the first embodiment of the present invention;

FIG. 12 is a flowchart of the operation of query execution server determination unit of the first embodiment of the present invention;

FIG. 13 is a flowchart of the operation of a query transfer unit of the first embodiment of the present invention;

FIG. 14 is a flowchart of the operation of a server information collection unit of the first embodiment of the present invention;

FIG. 15 shows the configuration of an AP server computer and a DB server computer of a second embodiment of the present invention;

FIG. 16 is a flowchart of the operation of a query execution server determination unit of the second embodiment of the present invention;

FIG. 17 shows the configuration of an AP server computer and a DB server computer of a third embodiment of the present invention;

FIG. 18 shows an example of a query transfer definition table of the third embodiment of the present invention; and

FIG. 19 is a flowchart of the operation of a query execution server determination unit of the third embodiment of the present invention.

### DESCRIPTION OF THE PREFERRED EMBODIMENTS

Embodiment 1 through Embodiment 3 will be explained below as a number of embodiments of a computer system comprising a data processing proxy server that applies a load balancing server related to an embodiment of the present invention. By so doing, it is supposed that all of the components of the load balancing server exist in the AP server computer. However, this is one example, and at least one part of the load balancing server can exist in a computer other than the AP server computer and DB server computer.

Prior to explaining Embodiment 1 through Embodiment 3, a method for determining if a DE query is to be executed by proxy, or if the DB query is to be transferred to the DB server computer and executed by the DB server (hereinafter to be called the “query execution server determination”) will be explained in detail using the following first through third methods as examples. In so doing, the DB query that is to be targeted for a query server execution determination will be called the “target DB query”.

The first and second methods are methods for calculating the cost required to execute the target DB query by proxy using the AP server computer (hereinafter to be called the “AP server query execution cost”) and the query execution cost required to transfer the target DB query to the DB server computer and execute this target DB query using the DB server (hereinafter to be called “DB server query execution cost”), comparing the calculated query execution costs, and carrying out a query execution server determination based on the result of this comparison (in this specification, “cost” signifies the extent to which a computer resource is consumed rather than a sum of money). The third method is one that carries out a query execution server determination based on the pattern of the target DB query. Each of the AP server query execution cost, DB server query execution cost, and target DB query pattern is an example of the above-mentioned computer resource consumption-related element.

For the first and second methods, the comparison of the AP server computer-based query execution cost and the query execution cost of transferring and executing the DB query using the DB server computer are expressed by the inequality of (Expression 1):

(AP server computer-based query execution cost)>(DB server computer-based query execution cost)+(query communication cost) (Expression 1)

Using the “AP server computer-based query execution cost”, “DB server computer-based query execution cost” and “query communication cost” calculated in the query execution server determination, if the inequality of (Expression 1) is realized, it is determined that the target DB query is to be transferred to the DB server computer and executed by the DB server, and if the inequality of (Expression 1) is not realized, it is determined that the target DB query is to be executed by proxy.

“AP server computer-based query execution cost” here signifies the length of time required to execute the target DB query using the AP server computer (hereinafter to be called the “AP execution time”). The “DB server computer-based query execution cost” signifies the length of time required to execute the target DB query using the DB server computer (hereinafter to be called the “DB execution time”). The “query communication cost” signifies the communication time incurred when transferring and executing the target DB query on the DB server computer.

It is desirable that the trade-off between performance and accuracy be taken into account when calculating (estimating) the respective query execution costs in (Expression 1). Calculating query execution costs with a high degree of accuracy gives rise to advanced operations for query execution cost calculations and processing for extracting the information required for these calculations. This runs the risk of system performance deteriorating due to the affects of the cost calculation processing comprising these operations and information extraction. Thus, in calculating query execution costs, it is desirable to employ a method that enables the carrying out of calculations of appropriate accuracy that take into account the impact on performance.

The first method is one that places priority on the accuracy of the calculations (estimations) of query execution costs. In the first method, the “AP server computer-based query execution cost” is calculated on the basis of an execution plan for the target DB query in the AP server computer, and the “DB server computer-based query execution cost” is calculated on the basis of an execution plan for the target DB query in the DB server computer. Processing procedures for the target DB query are described in the execution plan, making it possible to learn the number of times that primitive operations, such as sequential access to user data, index scan, and so forth (hereinafter to be called the “number of execution steps”), are to be carried out when executing the target DB query. Multiplying the length of execution time required for primitive operations by this number of execution steps can be expected to enable highly accurate cost calculations. Accordingly, it is possible to calculate the “AP server computer-based query execution cost” by multiplying the length of execution time required for primitive operations by the number of execution steps shown in the execution plan when executing the target DB query in the AP server computer. Further, it is possible to calculate the “DB server computer-based query execution cost” by multiplying the length of execution time required for primitive operations by the number of execution steps in the execution plan when executing the target DB query in the DB server computer.

The “query communication cost” is calculated using the sum total of the communication cost for transferring the target DB query from the AP server computer to the DB server computer, and the communication cost for transferring the result of target DB query execution from the DB server computer to the AP server computer. More specifically, for example, the “query communication cost” is calculated by dividing the sum total of the size of the target DB query (hereinafter to be called the “query size”) and the size of the result of target DB query execution (hereinafter to be called the “query result size”) by the transfer rate between the AP server computer and the DB server computer.

From the above, it is possible to define (Expression 1) in the first method as the following (Expression 2):

(Number of query execution steps in AP server computer)×(Length of execution time per execution step in the AP server computer)>(Number of query execution steps in DB server computer)×(Length of execution time per execution step in the DB server computer)+((Query size)+(Query result size))/(Transfer rate) (Expression 2)

The second method simplifies the calculation of the “DB server computer-based query execution cost” of the first method. For example, (1) through (3) below are necessary to calculate the “DB server computer-based query execution cost”:

(1) Collection of information for creating a DB server-managed execution plan (information necessary for creating an execution plan, for example, a data dictionary);

(2) Collection of length of execution time for an execution step; and

(3) Using the collected information for creating an execution plan and length of execution time for an execution step to calculate the length of execution time of the target DB query.

Computer load is thus generated. In the second method, it is possible to reduce the load on the computer more than in the first method.

If it is supposed that the AP server caches the same data dictionary and user data as the DB server, the number of execution steps of the AP server computer and DB server computer for the target DB query will be identical. This is because the number of execution steps is calculated based on the data dictionary and user data. Therefore, as a result, the difference of the two query execution costs can be approximated by introducing the ratio of DB server processing performance relative to the AP server (hereinafter to be called the “DB server performance ratio”). More specifically, it is possible to approximate the “DB server computer-based query execution cost” by multiplying the “DB server performance ratio” by the “AP server computer-based query execution cost”.

From the above, it is possible to define (Expression 2) as the following (Expression 3):

(Number of query execution steps in AP server computer)×(Length of execution time per execution step in the AP server computer)>(AP server computer-based query execution cost)×(DB server performance ratio)+((Query size)+(Query result size))/(Transfer rate) (Expression 3)

As one specific method for calculating the “DB server performance ratio”, a method that determines the ratio of the average length of execution time of the DB server per DB query relative to the AP server (hereinafter to be called the “average length of time for query execution”) is possible. The “DB server performance ratio” computer in this case is defined by the following (Expression 4):

(DB server performance ratio)=(Average length of time for query execution in the DB server computer)/(Average length of time for query execution in the AP server computer) (Expression 4)

The reason for using the average length of time for query execution to calculate the “DB server performance ratio” is as follows. That is, it is because the process for receiving a DB query and responding with the result of the execution thereof can be grasped as queuing, and it is deemed appropriate to employ the average length of time for query execution corresponding to the average wait time of the Queuing Theory as the performance ratio. More specifically, in the M/M/1 model of the Queuing Theory, when the average value of the number of calls reached in a unit of time is treated as λ, and the average value of the number of calls capable of being serviced by switching equipment in a unit of time is treated a μ, the average service time is represented as ts (=1/μ), and the utilization ratio λ/μ, which is the percentage of time actually used by the switching equipment, is represented as ρ, the finding is that the average wait time is ρ/(1−ρ)×ts. If the average wait time is replaced by the average length of time for query execution here, the average length of time for query execution suddenly increases as the utilization ratio approaches 1, and this resembles the change in the average length of time for query execution in an ordinary database.

Furthermore, in calculating the “DB server performance ratio”, it is also possible to utilize various types of processing capabilities, such as CPU utilization time, either instead of or in addition to the average length of time for query execution.

The third method is a simpler query execution server determination method than the first and second methods. The third method, based on the viewpoint that the query pattern and the degree of computer resource consumption are related, selects the query pattern as an example of a computer resource consumption-related element. More specifically, for example, the third method is based on the assumption that, when the target DB query coincides with a specified pattern, the target DB query satisfies (Expression 1). That is, when the target DB query coincides with the specified pattern, a determination is made to transfer the target DB query to the DE server computer. A DB query which tends to realize the inequality of (Expression 1) is one that is CPU intensive and has a small query result size. An example of a DB query that coincides with this includes a Group By phrase. The Group By phrase is used when grouping together column data, and totalizing the totals and averages for the same group. The execution plan for this sorts the data set of the column specified by the Group By phrase, and totalizes the sorted data set, and as such tends to be CPU intensive. Further, grouping reduces the number of query results for a DB query, and as a result, the query result size tends to be small. Accordingly, when a target DB query comprising a Group By phrase is detected, a determination is made to transfer the target DB query to the DB server computer based on the assumption that the target DB query satisfies the inequality of (Expression 1). A DB query having a query pattern that tends to be CPU intensive and to have a small query result size can include a DB query that carries out sort processing or a column data sequential operation in addition to one comprising a Group By phrase. For example, even in a JOIN-specified inner join, a column data sort process or column data collate process in a join-targeted table becomes CPU intensive depending on the join type thereof. Furthermore, when the join-source table is small, the join result becomes small, and the query result size is also small.

A specified query pattern is a query pattern in which the length of execution time for a database query when this database query is executed by proxy is greater than the sum of the length of query execution time when this database query is executed by the DB server, and the length of communication time incurred by transferring this database query via the DB server (the length of communication time required for communications between the AP server computer and the DB server computer). Preferably, the database query of the specified query pattern is a query that has higher computer resource consumption than a database query of another query pattern and that has a smaller query result size than a database query of another query pattern.

As described hereinabove, in the third method, the query execution server determination is carried out based on the query pattern of the DB query.

A number of embodiments of the present invention will be explained in detail hereinbelow while referring to the figures. At this time, the processing that the CPU carries out by reading in and executing a computer program may be attributed to the computer program rather than the CPU for ease of explanation.

### Embodiment 1

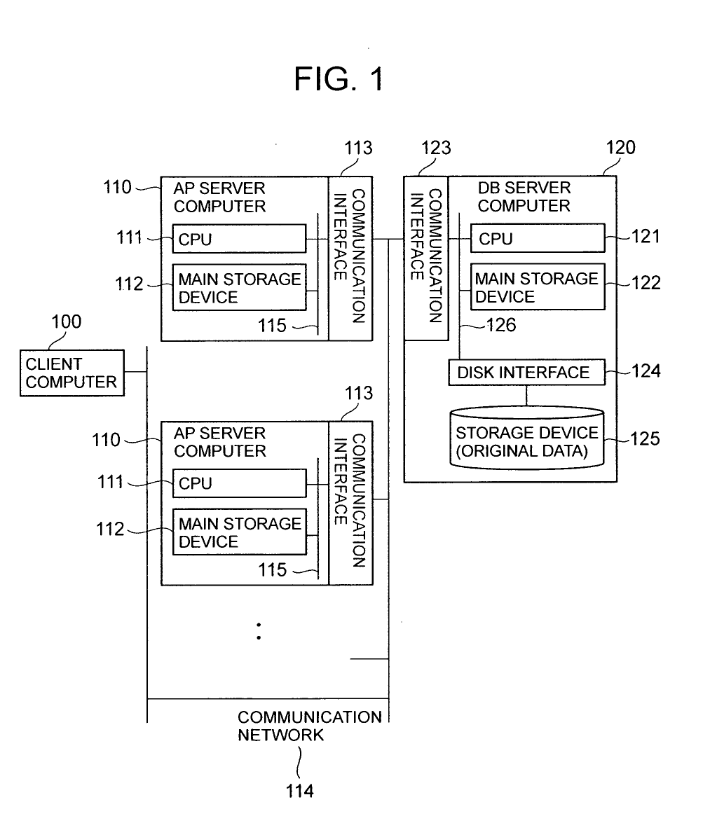

FIG. 1 is a block diagram showing the configuration of a computer system related to Embodiment 1 of the present invention.

A client computer 100, one or more AP server computers 110, and a DB server computer 120 are connected to a communication network 114, such as a LAN (Local Area Network) or WAN (Wide Area Network). Consequently, the computers 100, 110 and 120 are capable of communicating with one another.

The client computer 100 is a user interface for exchanging and processing a request specified from the user with the AP server computer 110.

The AP server computer 110 is configured from a processor, such as a CPU (Central Processing Unit) 111; a main storage device (memory) 112; a communication interface 113; and a bus 115 for connecting these components. The AP server computer 110 is connected to the communication network 114 via the communication interface 113. The CPU 111 executes a variety of programs stored in the main storage device 112. The main storage device 112 holds various data on which a program executes processing.

The DB server computer 120 is configured from a CPU 121 or other such processor; main storage device (memory) 122; communication interface 123; disk interface 124; storage device 125; and a bus 126 for connecting these components. The DB server computer 120 is connected to the communication network 114 via the communication interface 123. The CPU 121 executes various programs stored in the main storage device 122. The main storage device 122 holds various data on which a program executes processing. The storage device 125, for example, is a hard disk or other such disk-type storage media drive, and as such, the interface device for the storage device 125 is a disk interface 124. However, the storage device 125 is not limited to such a drive, and other types of storage devices can also be employed.

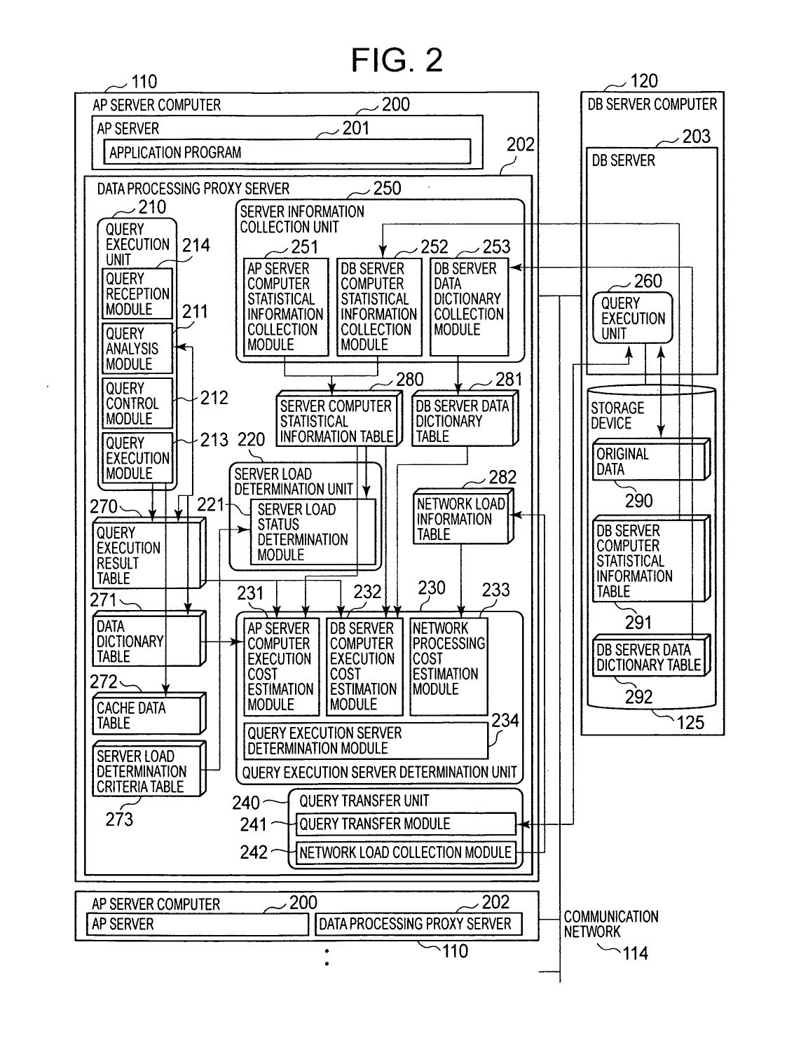

FIG. 2 shows the configurations of the AP server computer 110 and the DB server computer 120.

The AP server 200 of the AP server computer 110 is a server program that executes an application program 201 in accordance with a request from the client computer 100. The application program 201 is configured from business logic for providing a service to the client computer 100, or a data access process.

In addition to the AP server 200, the AP server computer 110 also comprises a data processing proxy server 202. Data processing proxy server 202 signifies a proxy server equipped with a cache function for original data 290 that comprises user data managed by the DB server computer 120, and can return from a cache data table 272 data that the application program 201 accesses. The cache data table 272 is either all or part of the original data 290. Consequently, since there is no need to access the DB server computer 120, a reduction in communication network 114 traffic, less load on the DB server computer 120, and shortened response time as viewed from the client computer 100 can be expected.

The data processing proxy server 202 has a query execution unit 210; a server load determination unit 220; a query execution server determination unit 230; a query transfer unit 240; and a server information collector 250.

The query execution unit 210 can carry out execution-by-proxy of a DB query from the AP server 200. The DB query, for example, is a SELECT statement, which is a read query, an INSERT statement, which is a write query, an UPDATE statement, and a DELETE statement in the case of SQL (Structured Query Language). SQL is a database manipulation language for carrying out data operations and definitions in a relational database management system (RDBMS). XPath or other such XML path languages, and XQuery (functional language for XML data query having a statically typed function) are also database manipulation languages. Furthermore, in Embodiment 1, the DB query also comprises a procedure program, called an SQL procedure, which brings together a series of processes comprising data access requests. In Embodiment 1, SQL is treated as the database manipulation language.

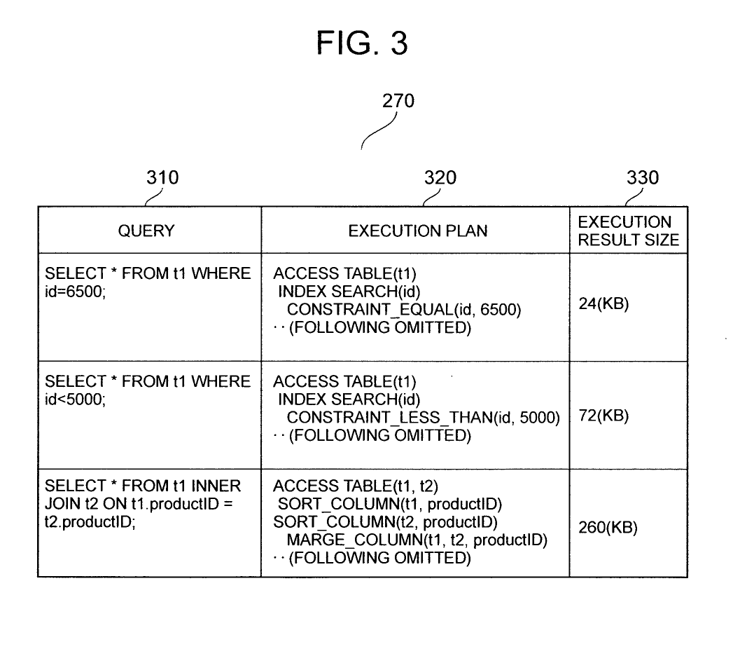

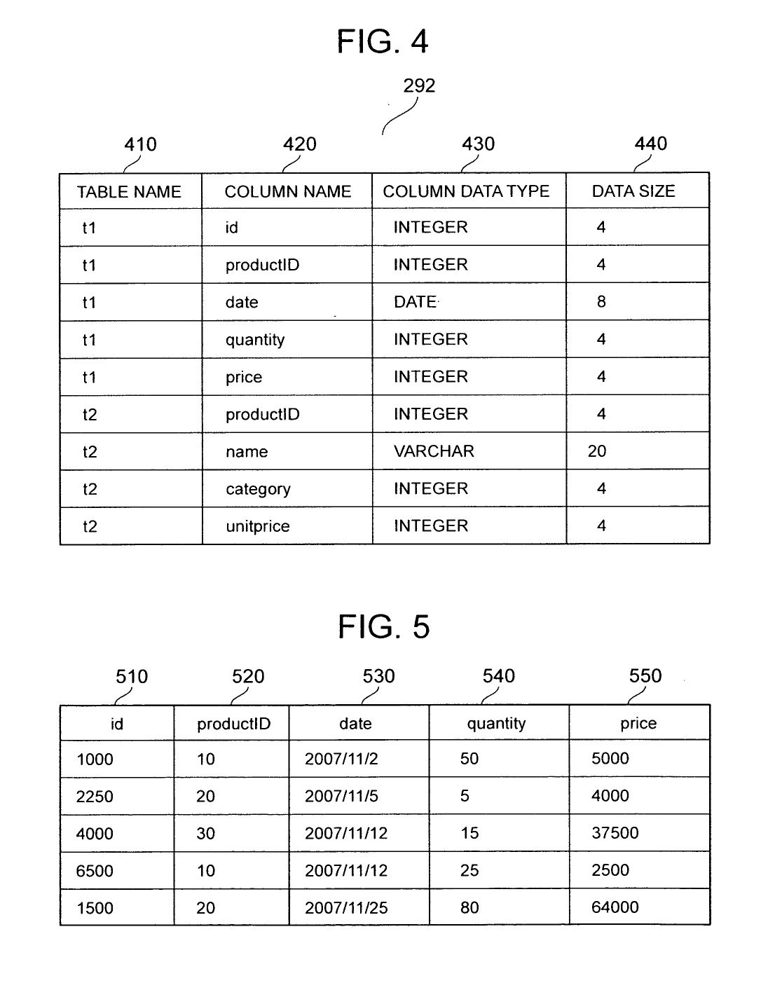

The query execution unit 210 is configured from a query reception module 214; a query analysis module 211; a query control module 212; and a query execution module 213. The query reception module 214 receives a DB query from the AP server 200. The query analysis module 211 uses a query execution result table 270 (refer to FIG. 3) and a data dictionary table 271 (refer to FIG. 4) to analyze a DB query received from the AP server 200. When the received DB query (target DB query) is to be executed by the DB server, the query control module 212 uses the server load determination unit 220 and query execution server determination unit 230 to boot up the query transfer unit 240, and to transfer the target DB query to the DB server computer and execute the target DB query using the DB server 203. When the DB query is to be executed by proxy by the data processing proxy server 202, the query execution module 213 uses the query execution result table 270 (refer to FIG. 3) and the cache data table 272 (refer to FIGS. 5 and 6) to execute this DB query by proxy. The query execution unit 210 returns the result of the execution-by-proxy of the DB query to the AP server 200.

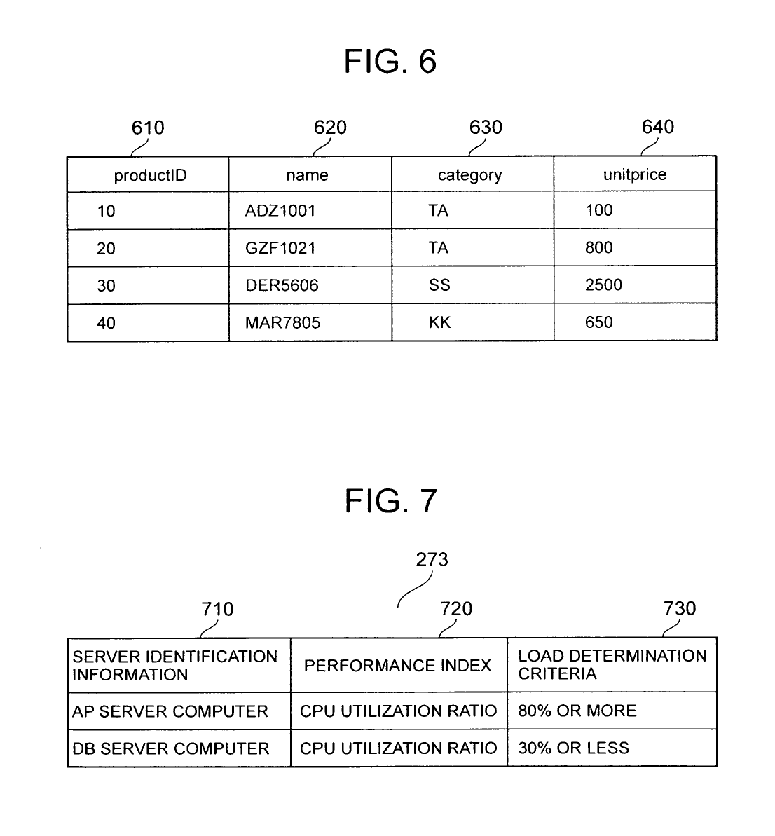

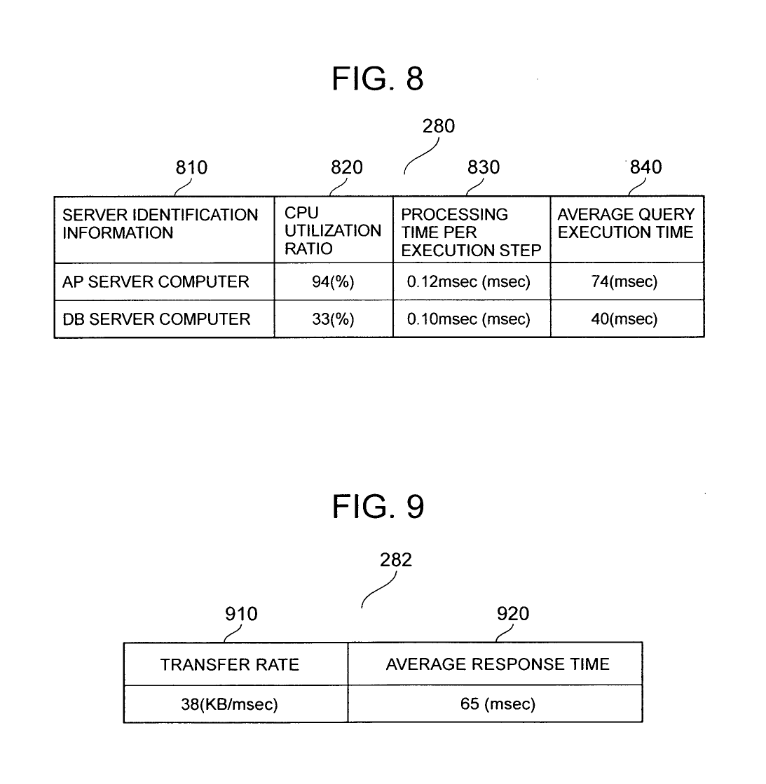

The server load determination unit 220 is booted up from the query execution unit 210, and is configured from a server load status determination module 221. The server load status determination module 221 uses the server load determination criteria table 273 (refer to FIG. 7) and the server computer statistical information table 280 (refer to FIG. 8) to determine whether or not the AP server computer 110 is in overload, and, in addition, whether or not the DB server computer 120 is in low load. Furthermore, the “AP server computer 110 is in overload”, for example, refers to the fact that either a prescribed type load of the AP server computer 110 (for example, the CPU utilization ratio) is higher than a first criteria value, or the prescribed type load of the AP server computer 110 is higher than that of the DB server computer 120. “DB server computer 120 is in low load”, for example, refers to the fact that either a prescribed type load of the DB server computer 120 (for example, the CPU utilization ratio) is lower than a second criteria value, or the prescribed type load of the DB server computer 120 is lower than that of the AP server computer 110. The first criteria value and the second criteria value can be the same criteria value, or different criteria values. In this case, the first criteria value can be either larger or smaller than the second criteria value.

The query execution server determination unit 230 is booted up from the query execution unit 210, and is configured from an AP server computer execution cost estimation module 231; a DB server computer execution cost estimation module 232; a network processing cost estimation module 233; and a query execution server determination module 234. The AP server computer execution cost estimation module 231 uses the query execution result table 270 managed by the data processing proxy server 202 (refer to FIG. 3), the data dictionary table 271 (refer to FIG. 4), and the server computer statistical information table 280 (refer to FIG. 8) to estimate the query execution cost in the AP server computer 110. The DB server computer execution cost estimation module 232 uses the query execution result table 270 (refer to FIG. 3), the data dictionary table 281 managed by the DB server 203 (refer to FIG. 4), and the server computer statistical information table 280 (refer to FIG. 8) to estimate the query execution cost in the DE server computer 120. The network processing cost estimation module 233 uses a network load information table 282 (refer to FIG. 9) to estimate the query communication cost. The query execution server determination module 234 determines if the target DB query is to be executed by proxy by the AP server computer 110, or transferred to the DE server computer 120 and executed by the DE server 203 from estimated values (the query execution cost of the AP server computer 110, query execution cost of the DB server computer 120, and the query communication cost) of the AP server computer execution cost estimation module 231, DB server computer execution cost estimation module 232, and network processing cost estimation module 233.

The query transfer unit 240 is booted up from the query execution unit 210, and is configured from a query transfer module 241; and network load collection module 242. The query transfer module 241 has the DB server 203 execute the target DB query, and returns the execution result received from the DB server 203 to the AP server 200. The network load collection module 242 collects information denoting the network load between the AP server and DB server, and writes the collected network load information to the network load information table 282 (refer to FIG. 9).

The server information collector 250 is configured from an AP server computer statistical information collection module 251; a DB server computer statistical information collection module 252; and a DB server data dictionary collection module 253. The AP server computer statistical information collection module 251 collects various statistical information such as the CPU utilization ratio and average length of time for query execution of the AP server computer 110, and writes the collected various statistical information to the server computer statistical information table 280 (refer to FIG. 8). The DB server computer statistical information collection module 252 collects various statistical information such as the CPU utilization ratio and average length of time for query execution of the DB server computer 120 from the DB server 203, and writes the collected various statistical information to the server computer statistical information table 280 (refer to FIG. 8). The DB server data dictionary collection module 253 acquires a DB server data dictionary table 292 managed by the DB server 203, and stores this data dictionary table 292 in the main storage device 112 as the DB server data dictionary table 281 (refer to FIG. 4).

The DB server 203 in the DB server computer 120 is a server program that executes a DB query in accordance with a request from the data processing proxy server 202. The DB server 203 holds original data 290 (refer to FIGS. 5 and 6), a DB server computer statistical information table 291 (refer to FIG. 8), and a DB server data dictionary table 292 (refer to FIG. 5) in the storage device 125. The DB server 203 has a query execution unit 260. The query execution unit 260 executes a DB query in accordance with a request from the data processing proxy server 202.

FIG. 3 shows an example of the query execution results table 270.

The query execution results table 270 is a table in which past query execution results are recorded. The respective rows of the table 270 correspond to the respective queries executed in the past, and the respective columns of table 270 comprise query 310, execution plan 320, and execution result size 330. Query 310 is the DB query character string that corresponds to the pertinent query 310. The execution plan 320 analyzes the DB query that corresponds to the pertinent execution plan 320, and shows the optimized processing procedure. Execution result size 330 is a numeric value that shows the size of the execution results of the DB query that corresponds to the pertinent execution result size 330. An example of a management method for this table 270 can include a method that carries out management in accordance with FIFO (First In First Out) or another such algorithm so as to fit into a previously specified number of upper limits and an upper limit size.

FIG. 4 shows an example of a data dictionary table 292.

The configuration of the table 292 shown in this figure is applicable to the data dictionary table 271 cached in the main storage device 112 inside the AP server computer 110, and the data dictionary table 281 of the DB server 203 cached in the main storage device 122 inside the DB server computer 120. The data dictionary table 292 is for managing various types of tables (for example, the tables t1, t2 that hold user data (refer to FIGS. 5 and 6)). The respective columns of table 292 comprise table name 410, column name 420, column data type 430, and data size 440. The table name 410 is a character string that shows the name of the table that corresponds to the pertinent table name 410. The column name 420 is a character string that shows the name of the column belonging to the table that corresponds to the pertinent column name 420. The column data type 430 is a character string that shows the data type (for example, int type or varchar type) of the column in the table that corresponds to the pertinent column data type 430. The data size 440 is a numeric value that shows the data size of the column in the table that corresponds to the pertinent data size 440. This table 292 manages the status of a table for user data relative to a table definition query, such as CREATE TABLE, DROP TABLE and ALTER TABLE.

FIG. 5 shows an example of a table t1 that holds user data.

Table t1 is included in original data 290, and is also included in cache data table 272. The respective columns of table t1 comprise id 510, product ID 520, date 530, quantity 540 and price 550. Referencing and updating are carried out for pertinent columns and rows in accordance with DB queries.

FIG. 6 shows an example of a table t2 that holds user date.

Table t2 is included in original data 290, and is also included in cache data table 272. The respective columns of table t2 comprise product ID 610, name 620, category 630 and unit price 640. Referencing and updating are carried out for pertinent columns and rows in accordance with DB queries.

FIG. 7 shows an example of a server load determination criteria table 273.

The server load determination criteria table 273 holds criteria information for determining server load. The respective columns of table 273 comprise server identification information 710, performance index 720 and load determination criteria 730. Server identification information 710 is identification information for identifying the server computer that corresponds to the pertinent server identification information 710 (the AP server computer 110 or DB server computer 120 that is the target of load determination), and constitutes a host name or an IP address. The performance index 720 is an index in the load determination, and is the CPU utilization ratio, throughput or other such character string. The load determination criteria 730 shows the criteria for determining whether or not the AP server computer 110 is in overload and whether or not the DB server computer 120 is in low load. According to the example of FIG. 7, the AP server computer 110 is in overload if the CPU utilization ratio is 80% or more, and the DB server computer 120 is in low load if the CPU utilization ratio is 30% or less. The load determination criteria 730 can be configured beforehand on the basis of the performance design of the system. Further, the load determination criteria 730 can also be dynamically changed automatically in response to feedback based on the state of system performance in order to properly determine the server load.

FIG. 8 shows an example of the server computer statistical information table 280.

The server computer statistical information table 280 holds statistical information related to the server computer. The respective columns of table 280 comprise server identification information 810, CPU utilization ratio 820, length of execution time per execution step 830, and average length of time for query execution 840. The server identification information 810 is identification information for identifying the server computer that corresponds to the server identification information 810 (the AP server computer 110 or DB server computer 120 that is the target of load determination), and constitutes a host name or an IP address. The CPU utilization ratio 820 is a numeric value that shows the CPU utilization ratio of the server computer that corresponds to the pertinent CPU utilization ratio 820. The length of execution time per execution step 830 is a numeric value that shows the time required to process one execution step of the DB query execution plan of the server computer that corresponds to the pertinent length of execution time 830. The average length of time for query execution 840 is a numeric value that shows the time required to execute one DB query using the server computer that corresponds to the pertinent average length of time for query execution 840. To curb the consumption of computer resources pursuant to collecting this statistical information, it is desirable to collect this statistical information regularly at pre-specified time intervals.

The DB server computer statistical information table 291 can take the same configuration as the server computer statistical information table 280. Moreover, server identification information 810 like that of table 280 can be eliminated.

FIG. 9 shows an example of the network load information table 282.

The network load information table 282 holds the load information of the network. The respective columns of table 282 comprise transfer rate 910 and average response time 920. The transfer rate 910 is a numeric value that shows the effective speed when data is being exchanged between the AP server computer 110 and the DB server computer 120. The average response time 920 is a numeric value that shows the time required to acquire a response result when the AP server computer 110 transfers the target DB query to the DB server computer 120. These values can be statically configured beforehand, but carrying out calculations based on actual measurements, such as configuring an average value for an actual query transfer, can be counted on to calculate more accurate communication costs that take performance status into account.

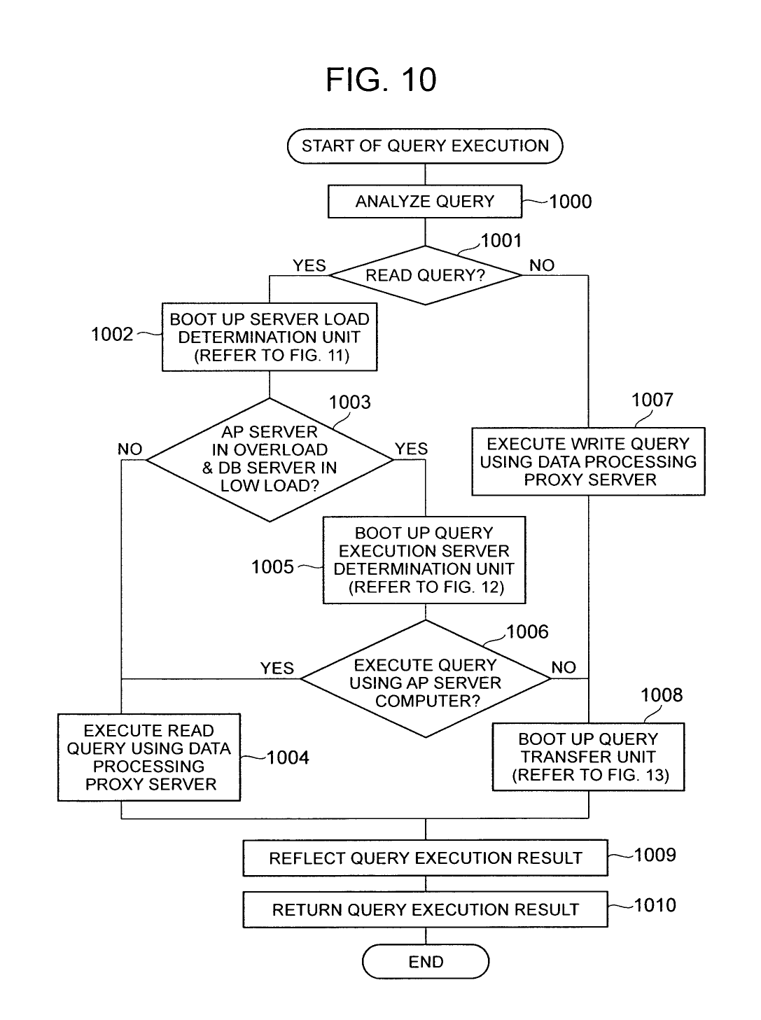

Next, the processing of the respective units in the data processing proxy server 202 will be explained by referring to FIGS. 1 through 9 as needed while referring to the flowcharts of FIGS. 10 through 14.

FIG. 10 is a flowchart of the operation of the query execution unit 210.

The query execution unit 210 receives a DB query from the AP server 200, and analyzes this DB query. In this Embodiment 1, in order to treat SQL as an example of a DB query, SQL statement analysis is carried out and an execution plan is created (Step 1000). When the DB query is not SQL, the query execution unit 210 responds to the AP server 200 with an error code or error message.

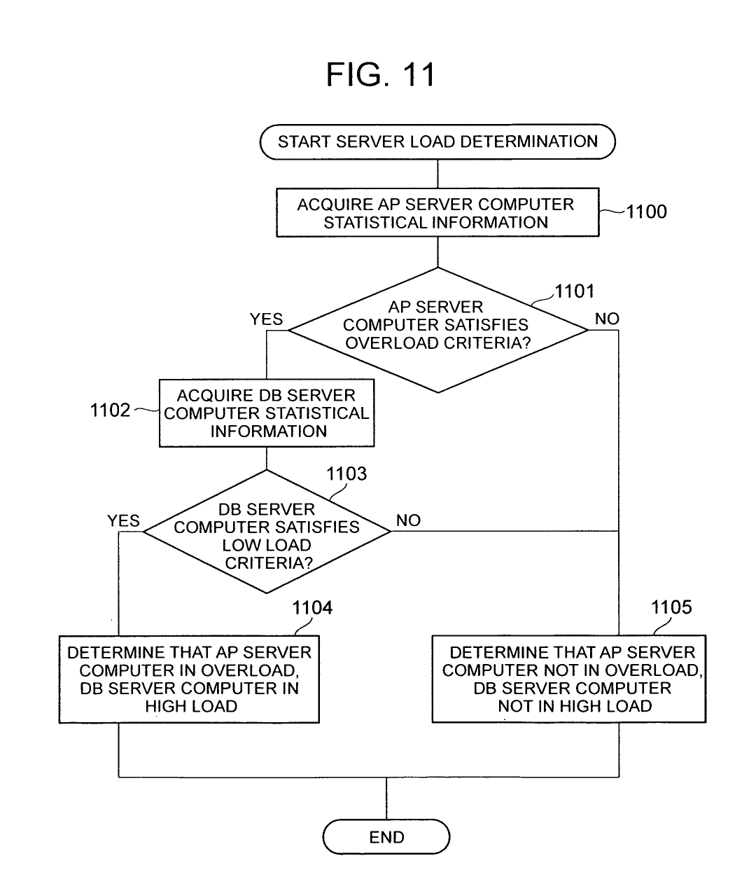

The query execution unit 210, based on the analysis of the received DB query, determines whether or not the received DB query (SQL) is the read query SELECT statement (Step 1001). When the received DB query is a read query, the query execution unit 210 executes Step 1002, and boots up the server load determination unit 220. Step 1002 will be explained in detail further below by referring to FIG. 11.

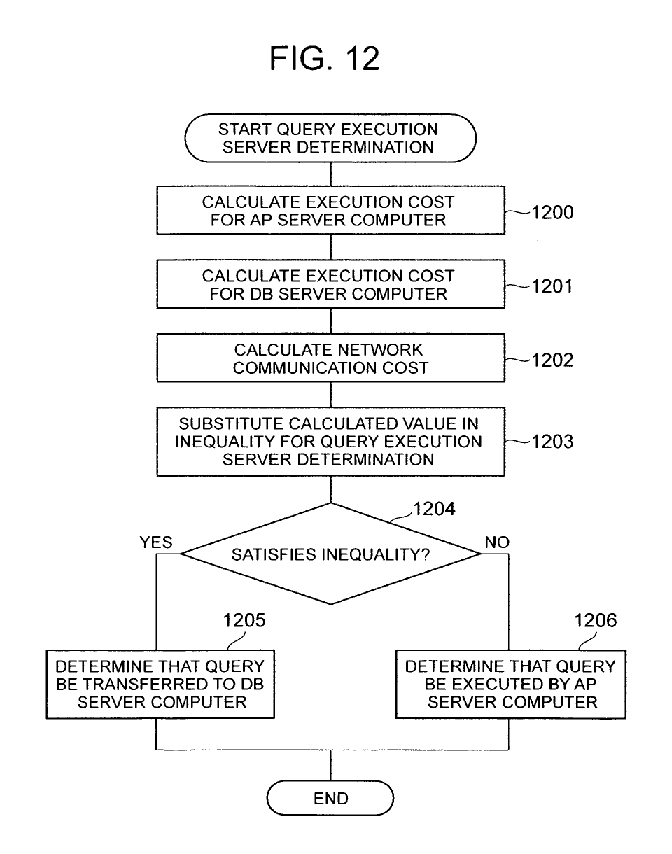

The query execution unit 210, based on the processing result of the server load determination unit 220 of Step 1002, determines whether or not the AP server computer 110 is in overload, and, in addition, whether or not the DB server computer 120 is in low load (Step 1003) In Step 1003, when it has been determined that the AP server computer 110 is not in overload, and/or the DB server computer 120 is not in low load, the query execution unit 210 executes the received DB query by proxy (Step 1004). When it has been determined that the AP server computer 110 is in overload, and, in addition, that the DB server computer 120 is in low load, the query execution unit 210 executes Step 1005 (boots up the query execution server determination unit 230). Step 1005 will be explained in detail further below by referring to FIG. 12.

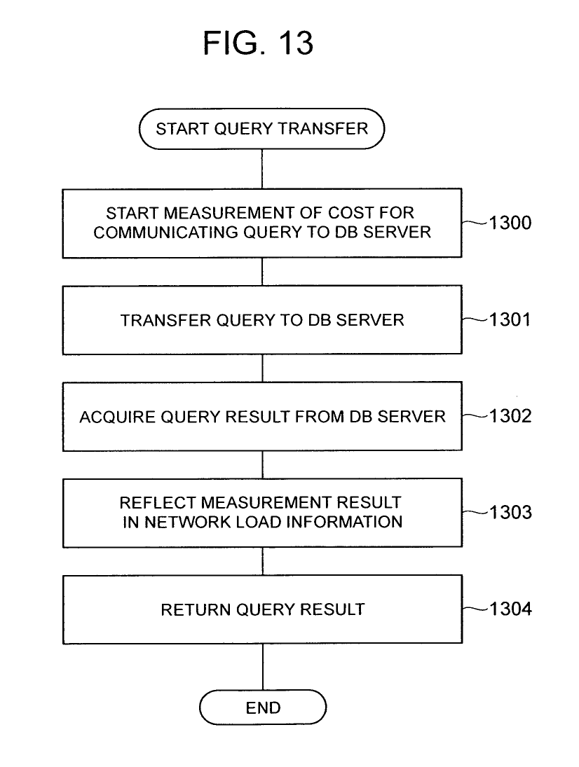

The query execution unit 210, based on the processing result of the query execution server determination unit 230 in Step 1005, determines whether or not to execute the received DB query (target DB query) by proxy (Step 1006). In Step 1006, when it has been determined that the target DB query is to be executed by proxy, Step 1004 is carried out, and when not, a determination is made to transfer the target DB query to the DB server 203, and thus Step 1008 (query transfer unit 240 is booted up) is carried out. Step 1008 will be explained in detail further below by referring to FIG. 13.

When the query execution unit 210 determines in Step 1001 that the received DB query is not a read query, that is, when the received DB query is any of the SQL write queries INSERT Statement, UPDATE Statement or DELETE Statement, the query execution unit 210 executes the received DB query, and reflects the user data update in the cache data table 272 (Step 1007). Next, the query execution unit 210 executes Step 1008 (boots up the query transfer unit 240). As a result, this DB query update is reflected in both the cache data table 272 managed by the data processing proxy server 202 and the original data 290 managed by the DB server 203. Consequently, it is possible to reference the latest user data (updated content) by issuing a read request to either the data processing proxy server 202 or the DB server 203. Further, when there are two or more AP server computers 110, it is possible to guarantee the data consistency of the original data 290 and the cache data table 272 by exercising control for an asynchronous reflection that utilizes an update log to reflect the update for the original data 290 managed by the DB server 203 in the cache data table 272 managed by all the AP server computers 110.

The query execution unit 210, based on the execution result of the received DB query, updates the query execution result table 270 (Step 1009). When the same DB query as the pertinent DB query exists in query 310 of the query execution result table 270, the average value of the execution result size 330 of the same DB query as the pertinent DB query and the execution result size of the pertinent DB query is written to the table 270 as the execution result size 330 of the pertinent DB query. Consequently, it is possible to calculate a more accurate query communication cost that takes into account an execution result size change generated in line with a change in user data. When the same DB query as the pertinent DB query does not exist, the query execution unit 210 adds the query 310, execution plan 320 and execution result size 330 for the pertinent DB query.

The query execution unit 210 responds to the AP server 200 with the execution result of the pertinent DB query, and ends processing (Step 1010).

FIG. 11 is a flowchart of the operation of the server load determination unit 220.

The server load determination unit 220 is booted up from the query execution unit 210, and commences a server load determination process. The server load determination unit 220, for example, acquires the CPU utilization ratio 820 from the server computer statistical information table 280 as the load information of the AP server computer 110 (Step 1100). Next, the server load determination unit 220 determines whether or not the AP server computer 110 satisfies load determination criteria based on the server load determination criteria table 273 (Step 1101).

When the AP server computer 110 satisfies the load determination criteria in Step 1101, the server load determination unit 220 determines that the AP server computer 110 is in overload, and, for example, acquires the CPU utilization ratio 820 from the server computer statistical information table 280 as the load information of the DB server computer 120 (Step 1102). Next, the server load determination unit 220 determines whether or not the DB server computer 120 satisfies load determination criteria based on the server load determination criteria table 273 (Step 1103).

When the DB server computer 120 satisfies the load determination criteria in Step 1103, the server load determination unit 220 determines that the DB server computer 120 is in low load, and determines that the AP server is in overload, and, in addition, that the DB server is in low load, and ends processing (Step 1104).

When the AP server does not satisfy the overload criteria in Step 1101, and, the DB server does not satisfy the low load criteria in Step 1103, the server load determination unit 220 determines that the AP server is not in overload, and/or that the DB server is not in low load, and ends processing (Step 1105).

FIG. 12 is a flowchart of the operation of the query execution server determination unit 230.

The query execution server determination unit 230 is booted up from the query execution unit 210, and commences a query execution server determination process. The query execution server determination unit 230 calculates the query execution cost for the AP server computer 110 (Step 1200). The AP server computer 110 query execution cost, as shown in (Expression 2) described hereinabove, can be expressed as (number of AP server query execution steps)×(length of AP server execution time per execution step). As the “number of AP server query execution steps”, for example, the estimated value of a query optimizer cost base can be employed. The query optimizer, in order to create the optimum execution plan for the target DB query, selects candidate execution plans for the target DB query, estimates costs using the data dictionary table 271 and so forth, and decides on the execution plan With the lowest cost. The “number of AP server query execution steps” can be the number of execution steps of the target DB query calculated in the cost base estimate. The “length of AP server execution time per execution step”, for example, can be the length of execution time per execution step 830 (length of execution time per execution step 830 corresponding to the AP server computer) recorded in the server computer statistical information table 280.

The query execution server determination unit 230 calculates the query execution cost of the DB server computer 120 (Step 1201). The query execution cost of the DB server computer 120, as shown in (Expression 2) described hereinabove, can be expressed as (number of DB server query execution steps)×(length of DB server execution time per execution step). The “number DB server query execution steps”, for example, can be calculated using the same procedure for calculating the query execution cost of the AP server computer 110. At this time, the query execution server determination unit 230 can approximate the number of execution steps of the target DB query in the DB server computer 120 by creating an execution plan using the data dictionary table 281 of the DB server 203.

The query execution server determination unit 230 calculates the communication cost (query communication cost) between the AP server computer 110 and the DB server computer 120 (Step 1202). The query communication cost, as was shown in (Expression 2) described hereinabove, can be expressed as ((query size)+(query result size))/(transfer rate). The “query size” is the value of the size of the target DB query to be transferred. This value can be ignored if it matches the length of the character string of the target DB query, and is sufficiently small relative to the query result size. The “query result size” is the value of the size of the target DB query execution result. Since the size of the execution result cannot be acquired until the DB query is actually executed, the value of this size is predicted. As an example of a prediction method, the value of the execution result size 330 for the target DB query can be predicted from the query execution result table 270. The “transfer rate” is the communication speed of the data transfer between the AP server computer 110 and the DB server computer 120. The “transfer rate”, for example, is the value of the transfer rate 910 of the network load information table 282.

The query execution server determination unit 230 substitutes the estimated values calculated in Steps 1200 through 1202 in (Expression 2), and determines whether or not the inequality is satisfied (Step 1203).

When the inequality of (Expression 2) is satisfied in Step 1203, the query execution server determination unit 230 makes a determination to transfer the target DB query to the DB server computer 120, and ends processing (Step 1205). When the inequality of (Expression 2) is not satisfied in Step 1203, the query execution server determination unit 230 determines that the target DB query is to be executed by proxy by the AP server computer 110, and ends processing (Step 1206).

FIG. 13 is a flowchart of the operation of the query transfer unit 240.

The query transfer unit 240 is booted up from the query execution unit 210, and commences a query transfer process. The query transfer unit 240 commences measuring the communication cost of the target DB query to the DB server computer 120 in order to update the transfer rate 910 and average response time 920 of the network load information table 282 (Step 1300). To curb the consumption of computer resources for this measurement process, measurements can also be carried out regularly at pre-specified time intervals. The query transfer unit 240 transfers the target DB query to the DB server 203 (Step 1301). The transfer is not limited to the target DB query at this time, but rather, it is also possible to transfer data (for example, the execution plan) that is rendered in a pattern executable by the DB server 203 instead of the target DB query.

The query transfer unit 240 acquires the target DB query execution result from the DB server 203 (Step 1302).

When measurement has been carried out for the target DB query, the query transfer unit 240 ends the measurement, and writes the transfer rate 910 and average response time 920, which are the results of this measurement, to the network load information table 282 (Step 1303).

The query transfer unit 240 returns the target DB query execution result acquired from the DB server 203 to the AP server 200 (Step 1304).

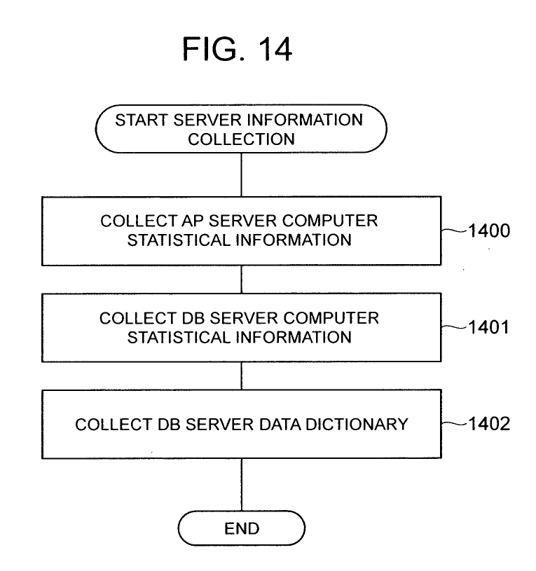

FIG. 14 is a flowchart of the operation of the server information collection unit 250.

The server information collection unit 250 is booted up from the query execution unit 210, and commences various information collection processes. The server information collection unit 250 collects the statistical information of the AP server computer 110 and updates the server computer statistical information table 280 (updates the column that comprises the server identification information 810 representing the AP server computer 110) (Step 1400). As one specific example for collecting the CPU utilization ratio 820, a method for collecting this ratio 820 using a system call that the operating system (OS) provides can be considered. A specific example for collecting the length of execution time per execution step 830 can include a method for measuring the processing of an execution step a plurality of times and calculating an average value of these measurements. A specific example for collecting the average length of time for query execution 840 can include a method for measuring the DB query process a plurality of times and calculating an average value of these measurements.

The server information collection unit 250 collects the statistical information of the DB server computer 120, and updates the server computer statistical information table 280 (updates the column that comprises the server identification information 810 representing the DB server computer 120) (Step 1401). The CPU utilization ratio 820, length of execution time per execution step 830 and average length of time for query execution 840 are acquired from the DB server computer statistical information table 291 managed by the DB server 203. As another method, it is also possible to transfer the values collected by the DB server computer 120 using the same procedures as those used for the AP server computer 110.

The server information collection unit 250 collects the DB server data dictionary table 292, and updates the DB server data dictionary table 281 (Step 1402) The dictionary tables are managed the same as the user tables, and can be referenced and collected using SQL.

In Steps 1400 through 1402 of the server information collection unit 250, the consumption of computer resources, such as the CPU and memory of the AP server computer 110, and communications between the AP server computer 110 and the DB server computer 120 occur in line with collecting the various types of data. For this reason, it is desirable that consideration be given to not affecting the DB query execution process while curbing resource consumption, such as collecting data asynchronously to the DB query execution process. In addition to asynchronous execution for the collection of the various data, control for adjusting collection frequency in accordance with resource margins is also effective. Further, the collection-targeted data, such as the CPU utilization ratio 820, length of execution time per execution step 830, and DB server data dictionary table 292, does not have to be collected all at the same time, but rather the respective collection processes can operate independently.

According to Embodiment 1, load balancing in accordance with the data processing proxy server 202 adjusts the load balance between the AP server computer 110 and the DB server computer 120, and makes effective use of the computer resources of both, thereby making it possible to realize stable system performance.

### Embodiment 2

Embodiment 2 of the present invention will be explained hereinbelow. In so doing, the points of difference with Embodiment 1 will mainly be explained, and explanations of the points in common with Embodiment 1 will be either omitted or simplified.

In Embodiment 1, the first method of the first through the third methods explained hereinabove is employed, but in Embodiment 2, the second method is used. The second method is one that simplifies the calculation of the “DB server query execution cost”, and is defined in accordance with (Expression 3) mentioned above. Consequently, the curbing of computer resource consumption for calculating the “DB server query execution cost” and the lessening of the performance impact on the application program can be expected.

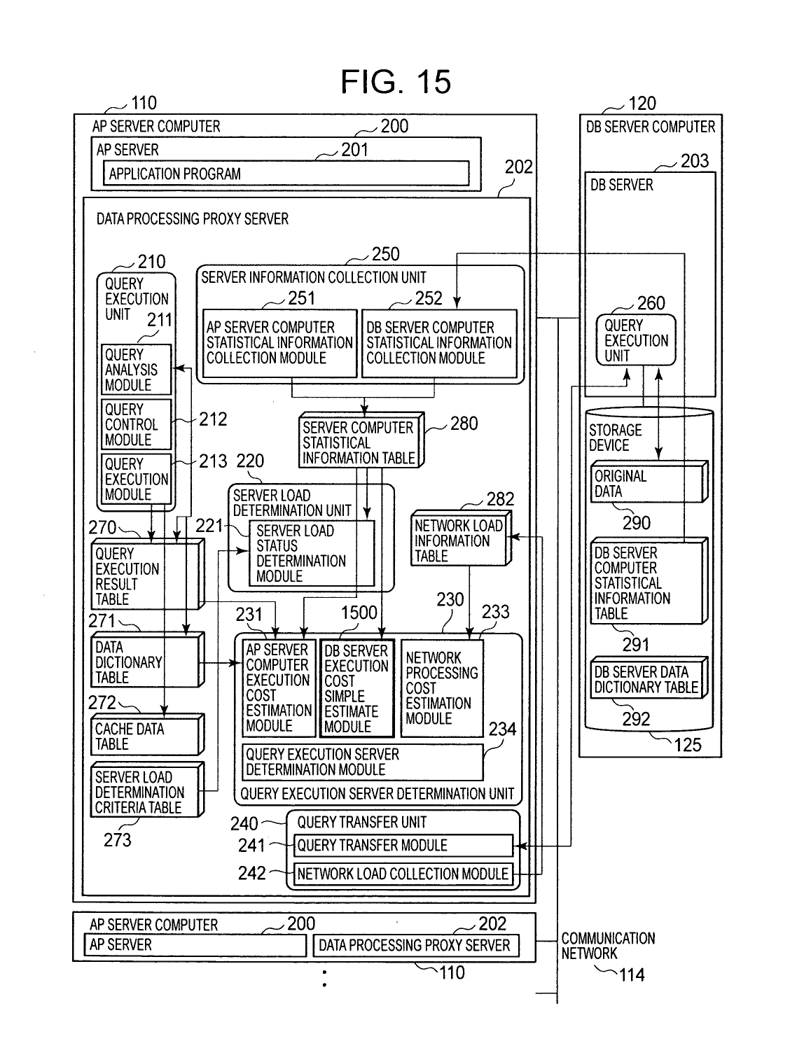

FIG. 15 shows the configuration of the AP server computer and DB server computer in Embodiment 2 of the present invention. In FIG. 15, the query reception module 214 has been omitted from the figure.

The query execution server determination unit 230 comprises a DB server execution cost simple estimate module 1500 instead of the DB server computer execution cost estimation module 232.

The DB server execution cost simple estimate module 1500 is for estimating the “DB server query execution cost” and does not use the DB server data dictionary table 281. Therefore, the DB server data dictionary table 281 of Embodiment 1, and the module related thereto are unnecessary.

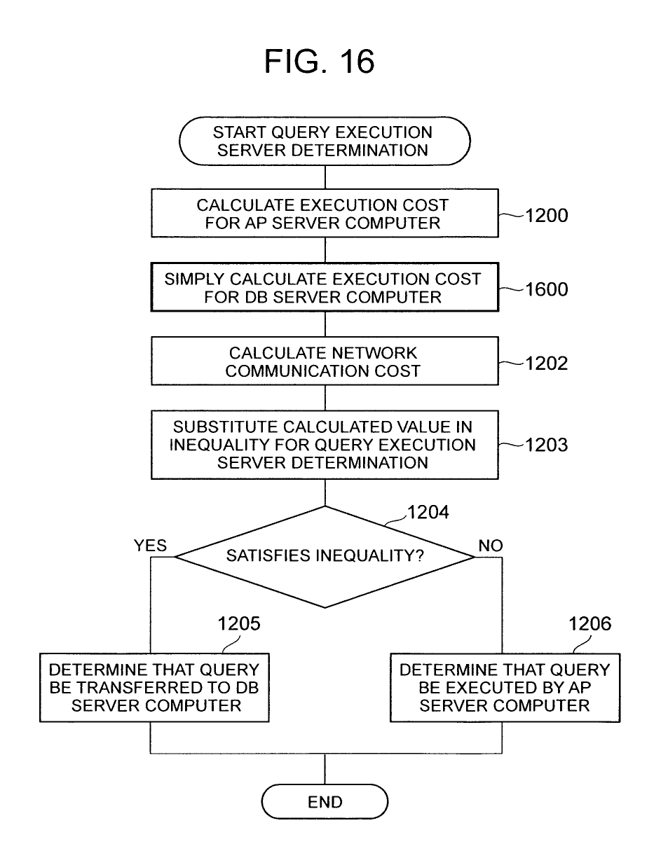

FIG. 16 is a flowchart of the operation of the query execution server determination unit 230.

The query execution server determination unit 230 simply estimates the query execution cost of the DB server computer 120 (Step 1600) instead of carrying out Step 1201 of FIG. 12. The query execution cost of the DB server computer, as shown in (Expression 3) mentioned above, can be expressed as (AP server computer query execution cost)×(DB server performance ratio). The “AP server computer query execution cost” can be the value calculated in Step 1200. Meanwhile, the (DB server performance ratio) can be expressed as (average length of time for DB server computer query execution)/(average length of time for AP server computer query execution) based on (Expression 4). As an example for calculating this value, it can be the value arrived at by respectively acquiring and dividing the average lengths of time for the query executions of the DB server computer 120 and the AP server computer 110 from the length of execution time per execution step 830 of FIG. 8. Thereafter, the processing of Step 1202 and beyond are the same as in FIG. 12.

### Embodiment 3

Embodiment 3 of the present invention will be explained hereinbelow. In so doing, the points of difference with Embodiment 1 (and/or Embodiment 2) will mainly be explained, and explanations of the points in common with Embodiment 1 (and/or Embodiment 2) will be either omitted or simplified.

In Embodiment 1 and Embodiment 2, the costs of executing the DB query in the AP server computer 110 and the DB server computer 120 are estimated, and based on this estimated value, a query execution server determination is carried out. By contrast, in Embodiment 3, when the DB query coincides with a specified query pattern, it is supposed that the DB query satisfies (Expression 1). That is, in Embodiment 3, the third method, which is the simplest query execution server determination method of the first through the third methods, is employed. Consequently, since the processes for estimating the costs in Embodiment 1 and Embodiment 2 are not carried out, lessening of the performance impact on the application program can be expected.

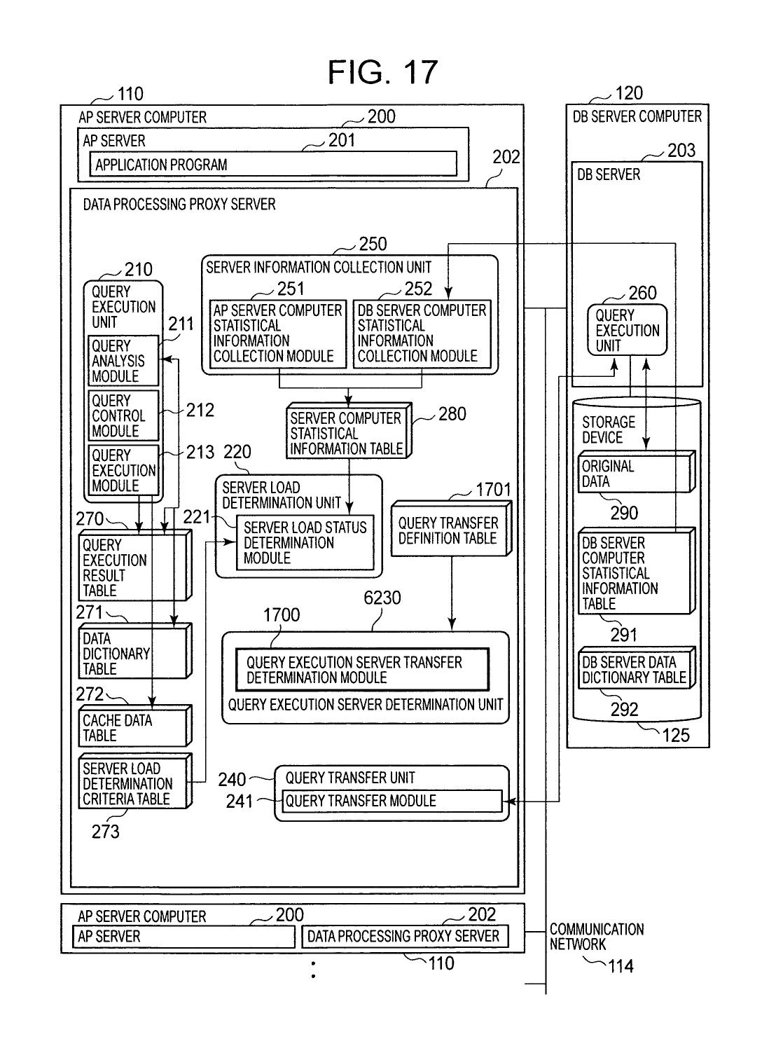

FIG. 17 shows the configurations of the AP server computer and DB server computer of Embodiment 3 of the present invention.

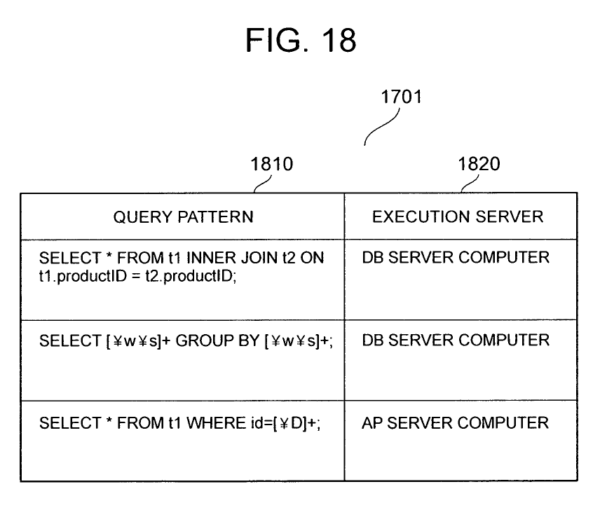

The query execution server determination unit 230 comprises a query execution server transfer determination module 1700 instead of the AP server computer execution cost estimation module 231, DB server computer execution cost estimation module 232 (or DB server execution cost simple estimate module 1500), network processing cost estimation module 233, and query execution server determination module 234. The query execution server transfer determination module 1700 uses a query transfer definition table 1701 (refer to FIG. 18) to determine whether or not to transfer the DB query.

FIG. 18 shows an example of the query transfer definition table 1701.

The query transfer definition table 1701 holds definition information related to the transfer of the DB query. The respective columns of the table 1701 comprise a DB query pattern 1810 that specifies whether or not a transfer is to be carried out, and an execution server 1820. The query pattern 1810 is a character string that shows the pattern of the targeted DB query. Specific examples for specifying the pattern can include specifying the DB query as a character string as-is, and specifying the DB query pattern using a regular expression. The execution server 1820 is server identification information for executing a DB query that matches the DB query pattern, and constitutes a host name or IP address. This definition information can be configured as needed from outside using an interface like a command line or definition file.

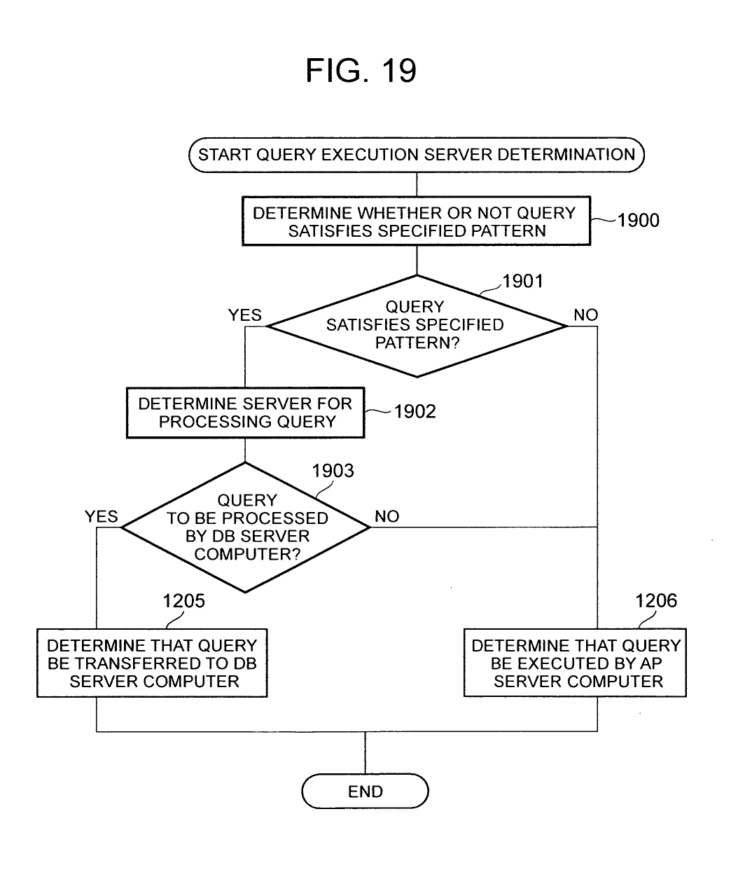

FIG. 19 is a flowchart of the operation of the query execution server determination unit 230.

The query execution server determination unit 230, based on the query transfer definition table 1701, determines whether or not the received target DB query satisfies the query pattern 1810 (Step 1900). In Step 1900, when it is determined that this DB query satisfies the query pattern 1810, a determination is made as to which server is to execute the target DB query based on the execution server 1820 (Step 1902). When it is determined that this DB query does not satisfies the query pattern 1810, the query execution server determination unit 230 proceeds to Step 1206, and the processing that follows is the same as that of FIG. 12.

When the target DB query is the specified query pattern, and as a result, the determination in Step 1902 is to execute the target DB query in the DB server computer 120, the query execution server determination unit 230 proceeds to Step 1205, and the processing that follows is the same as that of FIG. 12. When this is not the case (for example, when the target DB query is a different specified query pattern, and as a result, the determination in Step 1902 is to execute the target DB query by proxy in the AP server computer 110), the query execution server determination unit 230 proceeds to Step 1206, and the processing that follows is the same as that of FIG. 12.

The numerous embodiments of the present invention described hereinabove are examples for explaining the present invention, and do not purport to limit the scope of the present invention solely to these embodiments. The present invention can be implemented in a variety of other modes without departing from the gist thereof.

For example, one data processing proxy server 202 is provided with a DB server computer execution cost estimation module 232, DB server execution cost simple estimate module 1500, and query execution server transfer determination module 1700, and the module to be booted up can be decided by which of the above-mentioned first through third methods is employed. For example, when a mode that places priority on accuracy is selected either automatically or manually, the DB server computer execution cost estimation module 232 can be booted up from among modules 232, 1500 and 1700, when a mode that places priority on balance is selected either automatically or manually, the DB server execution cost simple estimate module 1500 can be booted up from among modules 232, 1500 and 1700, and when a mode that places priority on performance is selected either automatically or manually, the query execution server transfer determination module 1700 can be booted up from among modules 232, 1500 and 1700.

Further, at least one of the query execution unit 210, query analysis module 211, query control module 212, query execution module 213, query reception module 214, server load determination unit 220, server load status determination module 221, query execution server determination unit 230, AP server computer execution cost estimation module 231, DB server computer execution cost estimation module 232, network processing cost estimation module 233, query execution server determination module 234, query transfer unit 240, query transfer module 241, network load collection module 242, server information collection unit 250, AP server computer statistical information collection module 251, DB server computer statistical information collection module 252, DB server data dictionary collection module 253, query execution unit 260, DB server execution cost simple estimate module 1500, or query execution server transfer determination module 1700 can be realized via hardware either instead of or in addition to the computer programs by make making integrated circuits as processors for carrying out various processing. When the respective processors are realized via hardware, the respective processing can be carried out mainly by these processors.

What is claimed is:

1. A load balancing server in a computer system having an AP server computer that runs an application server (AP server) for executing an application program that carries out processing in accordance with a request from a client, and a DB server computer that runs a database server (DB server) for executing a database query, the load balancing server comprising:
a query receiver for receiving a database query from the AP server;
a query analyzer for analyzing the database query received by the query receiver;
a query execution unit for executing the database query in place of the DB server;
a query transfer unit for transferring the database query, which has not been executed by the query execution unit, to the DB server computer; and
a query execution server determination unit for determining whether the received database query is to be executed by the query execution unit, or is to be transferred to the DB server computer and executed by the DB server, based on a computer resource consumption-related element, which is an element related to an extent of computer resource consumption resulting from an execution of the database query, and obtained on the basis of a result of the database query analysis by the query analyzer,
wherein, when the query execution server determination unit determines that the database query is to be executed by the query execution unit, the query execution unit executes the database query, and
when the query execution server determination unit determines that the database query is to be transferred to the DB server computer and executed by the DB server, the query transfer unit transfers the database query to the DB server computer.

2. The load balancing server according to claim 1, wherein the computer resource consumption-related element is a first computer resource consumption-related value, which is a value related to computer resource consumption concerning executing the database query by the query execution unit, and a second computer resource consumption-related value, which is a value related to computer resource consumption concerning transferring the database query to the DB server computer and executing the database query by the DB server.

3. The load balancing server according to claim 2, wherein the first resource consumption-related value is a first length of time for query execution that is a length of time for the database query execution by the query execution unit, and
the second resource consumption-related value is a value based on a second length of time for query execution that is a length of time for query execution when the database query is executed by the DB server, and a length of communication time required for communications between the AP server computer and the DB server computer carried out in accordance with a transfer of the database query via the DB server.

4. The load balancing server according to claim 3, wherein a result of the database query analysis by the query analyzer is a first execution plan, which is a database query execution plan of a computer that runs the query execution unit,
the first length of time for query execution is calculated based on the first execution plan and a processing capacity of the AP server computer,
the second length of time for query execution is calculated based on a second execution plan, which is a database query execution plan of the DB server computer, and a processing capacity of the DB server computer, and
the length of communication time is calculated based on a size of the database query transferred to the DB server computer from the AP server computer, a size of a query result sent as a response from the DB server computer to the AP server computer, and a rate of communications between the AP server computer and the DB server computer.

5. The load balancing server according to claim 3, wherein a result of the database query analysis by the query analyzer is a first execution plan, which is a database query execution plan of a computer that runs the query execution unit,
the first length of time for query execution is calculated based on the first execution plan and a processing capacity of the AP server computer,
the second length of time for query execution is calculated based on the first length of time for query execution, and a processing performance ratio of the DB server relative to the AP server, and
the length of communication time is calculated based on a size of the database query transferred to the DB server computer from the AP server computer, a size of a query result sent as a response from the DB server computer to the AP server computer, and a rate of communications between the AP server computer and the DB server computer.

6. The load balancing server according to any one of claims 2 through 5, wherein the query execution server determination unit, when the first length of time for query execution is greater than a sum of the second length of time for query execution and the length of communication time, determines that the received database query is to be transferred to the DB server computer and executed by the DB server.

7. The load balancing server according to claim 1, therein the computer resource consumption-related element is a query pattern of the received database query, and
the query execution server determination unit, when the query pattern of the received database query is a specified query pattern, determines that the received database query is to be transferred to the DE server computer and executed by the DB server.

8. The load balancing server according to claim 7, wherein the specified query pattern is a query pattern in which a length of time for the database query execution by the query execution unit becomes greater than a sum of a length of time for query execution when the database query is executed by the DB server and a length of communication time required for communications between the AP server computer and the DB server computer carried out in accordance with a transfer of the database query via the DB server.

9. The load balancing server according to claim 7, wherein an amount of computer resource consumption of a database query of the specified query pattern is higher than that of a database query of another query pattern, and a query result size is smaller than that of a database query of the other query pattern.

10. The load balancing server according to claim 7, wherein the query execution server determination unit, when the query pattern of the received database query is a different specified query pattern, determines that the received database query is to be executed by the query execution unit.

11. The load balancing server according to claim 1, wherein the query execution server determination unit, when the AP server computer is in overload and the DB server computer is in low load, makes a determination as to whether the received database query is to be executed by the query execution unit, or is to be transferred to the DB server computer and executed by the DB server.

12. The load balancing server according to claim 1, wherein the query execution server determination unit, when the AP server computer is not in overload, or when the DB server computer is not in low load, decides that the received database query is to be executed by the query execution unit without making a determination as to whether the received database query is to be executed by the query execution unit, or is to be transferred to the DB server computer and executed by the DB server.

13. The load balancing server according to claim 1, wherein the query transfer unit, when the database query is to be transferred to the DB server computer, transfers data rendered in a pattern that is executable by the DE server in place of the received database query.

14. The load balancing server according to claim 1, wherein the query execution unit processes a portion of a database manipulation language or an SQL procedure as the database query.

15. A load balancing method executed by a computer system having an AP server computer that runs an application server (AP server) for executing an application program that carries out processing in accordance with a request from a client, and a DE server computer that runs a database server (DE server) for executing a database query, the load balancing control method comprising the steps of:
receiving a database query from the AP server;
analyzing the database query;
determining whether the received database query is to be executed by a query execution unit, or is to be transferred to the DE server computer and executed by the DE server, based on a computer resource consumption-related element, which is an element related to an extent of computer resource consumption resulting from an execution of the database query, and obtained on the basis of a result of the database query analysis;
executing the database query by the query execution unit instead of the DB server when it is determined that the database query is to be executed by the query execution unit, and
transferring the database query to the DB server computer when it is determined that the database query is to be transferred to the DB server computer and executed by the DB server.

16. A computer program executed by one or more computers having an AP server computer and/or another type of computer different from the AP server computer, inside a computer system that comprises the AP server computer that runs an application server (AP server) for executing an application program that carries out processing in accordance with a request from a client, and a DB server computer that runs a database server (DB server) for executing a database query, the computer program executing the steps of:
receiving a database query from the AP server;
analyzing the database query;
determining whether the received database query is to be executed by the computer program instead of the DB server, or is to be transferred to the DB server computer and executed by the DB server, based on a computer resource consumption-related element, which is an element related to an extent of computer resource consumption resulting from an execution of the database query, and obtained on the basis of a result of the database query analysis;
executing the database query by the computer program instead of the DB server when it is determined that the database query is to be executed by the computer program, and
transferring the database query to the DB server computer when it is determined that the database query is to be transferred to the DB server computer and executed by the DB server.
